(19) United States
(12) Patent Application Publication
(10) Pub. No.: US 2026/0112752 A1
(43) Pub. Date: Apr. 23, 2026

(54) BATTERY MODULE

(71) Applicants: Hyundai Motor Company, Seoul (KR); Kia Corporation, Seoul (KR)

(72) Inventors: Hyun Chang Kang, Hwaseong (KR); In Gook Son, Hwaseong (KR); Young Hoo Oh, Hwaseong (KR); Jun Seok Choi, Hwaseong (KR); Jun Young Kang, Hwaseong (KR)

(21) Appl. No.: 19/345,375

(22) Filed: Sep. 30, 2025

(30) Foreign Application Priority Data
Oct. 18, 2024 (KR) 10-2024-0142960
May 20, 2025 (KR) 10-2025-0065506

(51) Int. Cl. H01M 50/24; H01M 10/48; H01M 10/647; H01M 10/658; H01M 50/209; H01M 50/273; H01M 50/291; H01M 50/503

(52) U.S. Cl. CPC H01M 50/24; H01M 10/482; H01M 10/647; H01M 10/658; H01M 50/209; H01M 50/273; H01M 50/291; H01M 50/503

(57) ABSTRACT

Disclosed is a battery module. The battery module may comprise a plurality of battery cells that are arranged in one direction, an end plate that is disposed on one side of the plurality of battery cells and supports the plurality of battery cells, a surface-pressure member that is disposed between the plurality of battery cells, and a cover member that is fixed by the end plate or the surface-pressure member, covers one surface of at least one battery cell, and is formed such that each of a plurality of spaces partitioned along the one direction, among spaces between the battery cells, is expandable by a specific pressure.

### CROSS-REFERENCE TO RELATED APPLICATION

This application claims, under 35 U.S. C. § 119(a), the benefit of Korean Patent Application No. 10-2024-0142960, filed Oct. 18, 2024, in the Korean Intellectual Property Office, and Korean Patent Application No. 10-2025-0065506, filed May 20, 2025, in the Korean Intellectual Property Office, the entire contents of which are incorporated herein by reference.

### BACKGROUND

### (a) Technical Field

The present disclosure relates to a battery module and to battery module configurations.

### (b) Background

As the demand for electric vehicles continues to increase, the demand for batteries mounted on electric vehicles is also increasing. Depending on the materials of the cathode and anode that constitute the battery, the battery may be classified into various types. Among them, a lithium-ion battery is widely used because it has high energy efficiency per unit volume and a lightweight structure. However, lithium-ion batteries pose a high risk of fire and explosion due to the strong reactivity of lithium.

As an example, when a fire occurs in some of a plurality of battery cells mounted in a battery module or battery pack, a thermal runaway may occur in the other battery cells due to a chain reaction when the thermal energy or gas generated by the fire is introduced into other adjacent battery cells.

### SUMMARY

The present disclosure has been made to solve the above-mentioned problems occurring in the prior art while advantages achieved by the prior art are maintained intact.

An aspect of the present disclosure provides a battery pack that may prevent a thermal runaway from occurring in adjacent battery cells even when a fire occurs in one of the battery cells.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a battery module includes a plurality of battery cells that are arranged in a direction, an end plate that is disposed on a side of the plurality of battery cells and supports the plurality of battery cells, a surface-pressure member that is disposed between the plurality of battery cells, and a cover member that is fixed by the end plate or the surface-pressure member, covers a surface of at least one battery cell, and is formed such that each of a plurality of spaces partitioned along the direction, among spaces between the battery cells, is expandable by pressure.

The cover member may include a support area supported by the end plate or the surface-pressure member, and a folding area connected to the surface area and configured to be folded.

The folding area may include a first folding area, and a second folding area that is connected to the first folding area, and is fixed to the first folding area on a side of the first folding area.

Facing surfaces of the first folding area and the second folding area may be bonded to each other.

The battery module may further include a fixing member that fixes the first folding area and the second folding area.

The battery module may further include a sensing assembly including a busbar electrically connected to the plurality of battery cells and a busbar frame that supports the busbar, and a sensing cover that covers the sensing assembly, and the busbar frame and the sensing cover may cover the cover member.

The busbar frame may include a frame body area that is covered by the sensing cover, and a frame protrusion area that protrudes from the frame body area to cover a portion of the cover member.

The sensing cover may include a cover body area that covers a surface of the busbar frame, and a cover protrusion area that protrudes from the cover body area to cover the cover member.

The cover member may be formed of a flexible material.

A pair of end plates may be provided to be disposed on opposite sides of the plurality of battery cells, and the cover member may include a pair of end fixing areas that are fixed to the pair of end plates, respectively, and a cover area that connects the pair of end fixing areas, and contacting the surface-pressure member.

The battery module may further include an end fixing member, through which the end fixing area and the end plates pass to fix the end fixing area, and a cover fixing member that brings a portion of the cover area into contact with the surface-pressure member.

The cover member may extend such that a direction crossing the direction in which the plurality of battery cells are arranged, becomes a lengthwise of the cover member so that the spaces communicate with each other with respect to a direction crossing the one direction.

The battery module may further include a cover frame that is fixed to the end plate or the surface-pressure member, and covering the cover member.

A pair of end plates may be provided to be disposed on opposite sides of the plurality of battery cells, and the cover frame may include a pair of plate coupling areas that are coupled to the pair of end plates, respectively, a frame cover area that covers the cover member and connecting the pair of plate coupling areas, and a partition area that protrudes from the frame cover area toward the surface-pressure member.

The cover member may be formed of a flame-retardant material or a heat-insulating material.

According to an aspect of the present disclosure, a battery module is provided. The battery module may comprise a plurality of battery cells. A plurality of spaces may be partitioned between the plurality of battery cells. The battery module may comprise an end plate configured to support the plurality of battery cells, a surface-pressure member disposed between the plurality of battery cells, and a cover member configured to cover a surface of at least one battery cell, of the plurality of battery cells. Each of the plurality of spaces partitioned may be configured to be expandable by pressure.

According to an exemplary embodiment, the cover member may comprise a support area supported by the end plate or the surface-pressure member and a folding area connected to the surface area and configured to be folded.

According to an exemplary embodiment, the folding area may comprise a first folding area and a second folding area connected to the first folding area and fixed to the first folding area on a side of the first folding area.

According to an exemplary embodiment, the first folding area and the second folding area may comprise facing surfaces, and the facing surfaces of the first folding area and the second folding area may be bonded to each other.

According to an exemplary embodiment, the battery module may comprise a fixing member configured to fix the first folding area and the second folding area.

According to an exemplary embodiment, the battery module may comprise a sensing assembly comprising a busbar electrically connected to the plurality of battery cells and a busbar frame configured to support the busbar, and a sensing cover configured to cover the sensing assembly. The busbar frame or the sensing cover may be configured to cover the cover member.

According to an exemplary embodiment, the busbar frame may comprise a frame body area covered by the sensing cover and a frame protrusion area configured to protrude from the frame body area to cover a portion of the cover member.

According to an exemplary embodiment, the sensing cover may comprise a cover body area configured to cover a surface of the busbar frame and a cover protrusion area configured to protrude from the cover body area to cover the cover member.

According to an exemplary embodiment, the cover member may comprise a flexible material.

According to an exemplary embodiment, the battery module may comprise a pair of end plates disposed on opposite sides of the plurality of battery cells. The cover member may comprise a pair of end fixing areas fixed to the pair of end plates, respectively and a cover area configured to connect the pair of end fixing areas and contact the surface-pressure member.

According to an exemplary embodiment, the battery module may comprise an end fixing member configured to enable the end fixing area and the end plates to pass therethrough to fix the end fixing area and a cover fixing member configured to bring a portion of the cover area into contact with the surface-pressure member.

According to an exemplary embodiment, the plurality of battery cells may be arranged in a direction, and the cover member may be configured to extend such that a direction crossing the direction in which the plurality of battery cells are arranged becomes a lengthwise of the cover member so that the plurality of spaces communicate with each other with respect to a direction crossing the one direction.

According to an exemplary embodiment, the battery module may comprise a cover frame fixed to the end plate or the surface-pressure member, and covering the cover member.

According to an exemplary embodiment, the battery module may comprise a pair of end plates disposed on opposite sides of the plurality of battery cells. The cover frame may comprise a pair of plate coupling areas coupled to the pair of end plates, respectively, a frame cover area configured to cover the cover member, and connect the pair of plate coupling areas, and a partition area configured to protrude from the frame cover area toward the surface-pressure member.

According to an exemplary embodiment, the cover member may comprise a flame-retardant material or a heat-insulating material.

According to an aspect of the present disclosure, a battery module is provided. The battery module may comprise an end plate configured to support a plurality of battery cells, a surface-pressure member disposed between the plurality of battery cells, and a cover member configured to cover a surface of at least one battery cell, of the plurality of battery cells.

According to an exemplary embodiment, the cover member may comprise a support area supported by the end plate or the surface-pressure member and a folding area connected to the surface area and configured to be folded.

According to an exemplary embodiment, the folding area may comprise a first folding area and a second folding area connected to the first folding area and fixed to the first folding area on a side of the first folding area.

According to an exemplary embodiment, the first folding area and the second folding area may comprise facing surfaces, and the facing surfaces of the first folding area and the second folding area may be bonded to each other.

According to an exemplary embodiment, the battery module may comprise a fixing member configured to fix the first folding area and the second folding area.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 illustrates a perspective view of a battery module, according to an exemplary embodiment of the present disclosure.

FIG. 2 illustrates a perspective view of components of a battery module excluding a sensing cover, according to an exemplary embodiment of the present disclosure.

FIG. 3 illustrates a transverse cross-sectional view of a battery module, according to an exemplary embodiment of the present disclosure.

FIG. 4 illustrates an enlarged view of FIG. 3, according to an exemplary embodiment of the present disclosure.

FIG. 5 illustrates an enlarged view illustrating a state, in which a space provided between a cover member and a battery cell is expanded when a fire occurs in the battery cell of FIG. 4, according to an exemplary embodiment of the present disclosure.

FIG. 6 illustrates a perspective view of a cover member, according to an exemplary embodiment of the present disclosure.

FIG. 7 illustrates a schematic view of a folding area, according to an exemplary embodiment of the present disclosure.

FIG. 8 illustrates a schematic view of a folding area, according to an exemplary embodiment of the present disclosure.

FIG. 9 illustrates an enlarged perspective view of a sensing cover, a bus bar frame, and a cover member, according to an exemplary embodiment of the present disclosure.

FIG. 10 illustrates a longitudinal cross-sectional view of a sensing cover, a bus bar frame, a cover member, and a battery cell, according to an exemplary embodiment of the present disclosure.

FIG. 11 illustrates a longitudinal cross-sectional view of a sensing cover, a bus bar frame, a cover member, and a battery cell, according to an exemplary embodiment of the present disclosure.

FIG. 12 illustrates a perspective view of a battery module, according to an exemplary embodiment of the present disclosure.

FIG. 13 illustrates an enlarged perspective view of a battery module, according to an exemplary embodiment of the present disclosure.

FIG. 14 illustrates a transverse cross-sectional view of a battery module, according to an exemplary embodiment of the present disclosure.

FIG. 15 illustrates a transverse cross-sectional view of a battery module illustrating a state, in which a space provided between a battery cell and a cover member is expanded due to a thermal transfer, according to an exemplary embodiment of the present disclosure.

FIG. 16 illustrates a transverse cross-sectional view of a battery module, according to an exemplary embodiment of the present disclosure.

### DETAILED DESCRIPTION

Hereinafter, some embodiments of the present disclosure will be described in detail with reference to the accompanying drawings. In the drawings, the same reference numerals will be used throughout to designate the same or equivalent components. In describing embodiments of the present disclosure, detailed descriptions associated with well-known functions or configurations will be omitted if they may make subject matters of the present disclosure unnecessarily obscure.

In describing components of embodiments of the present disclosure, the terms first, second, A, B, (a), (b), and the like may be used herein. These terms are only used to distinguish one component from another component, but do not limit the corresponding components irrespective of the nature, order, or priority of the corresponding components. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

In addition, terms such as first, second, and the like used herein may be used to describe various components, but the various components are not limited by these terms. The terms are used solely for the purpose of distinguishing one component from other components. For example, a first component may be referred to as a second component, and a second component may also be referred to as a first component, without departing from the scope of rights according to the inventive concepts of the present disclosure.

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well-known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Hereinafter, various embodiments disclosed in the present disclosure will be described in detail with reference to the accompanying drawings, and the same or similar elements are designated by the same reference numerals regardless of the numerals in the drawings and redundant description thereof will be omitted.

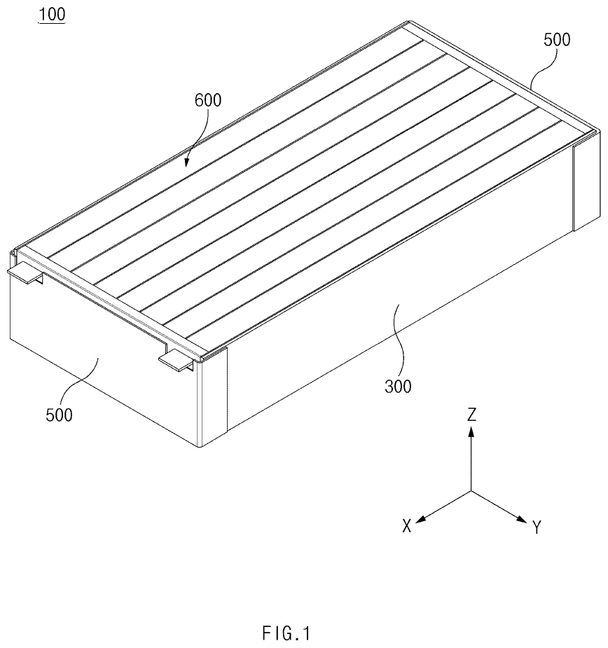

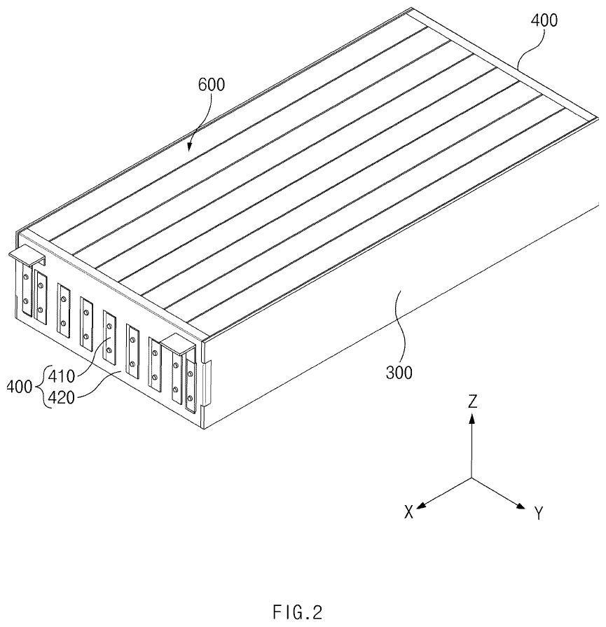

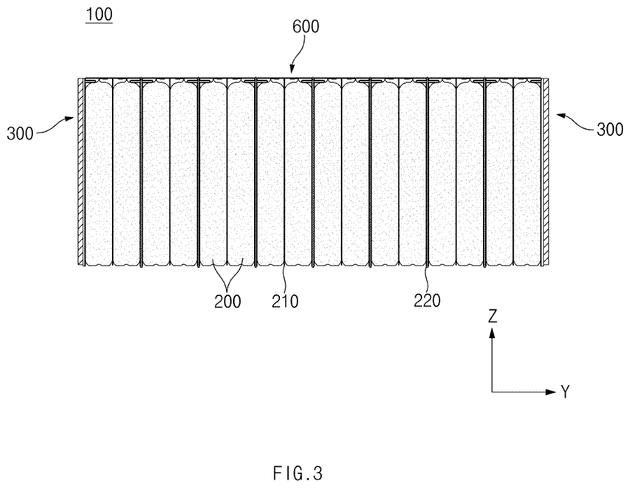

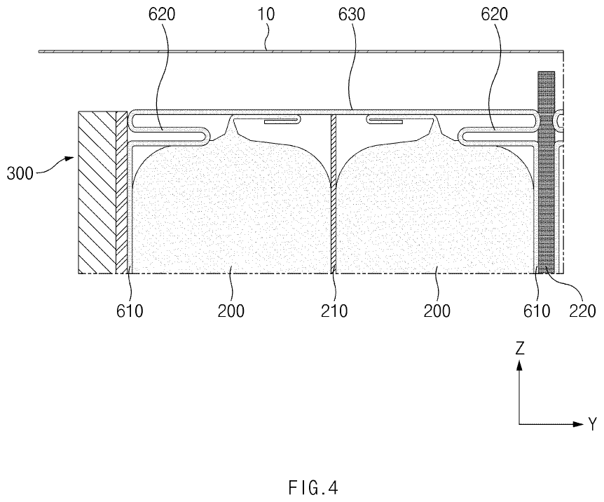

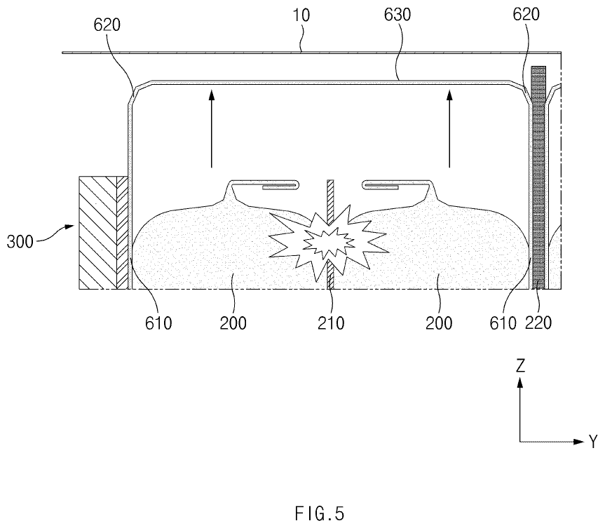

FIG. 1 illustrates a perspective view of a battery module, according to an exemplary embodiment of the present disclosure. FIG. 2 illustrates a perspective view of components of a battery module excluding a sensing cover, according to an exemplary embodiment of the present disclosure. FIG. 3 illustrates a transverse cross-sectional view of a battery module, according to an exemplary embodiment of the present disclosure. FIG. 4 illustrates an enlarged view of FIG. 3, according to an exemplary embodiment of the present disclosure. FIG. 5 illustrates an enlarged view illustrating a state, in which a space provided between a cover member and a battery cell is expanded when a fire occurs in the battery cell of FIG. 4, according to an exemplary embodiment of the present disclosure.

Referring to FIGS. 1 to 5, a battery module 100 may comprise a plurality of battery cells 200, one or more end plates 300, a sensing assembly 400, one or more sensing covers 500, and a cover member 600.

The plurality of battery cells 200 may be configured to extend in a first direction (the “X” direction or an opposite direction to the “X” direction), and may be arranged in a second direction (the “Y” direction or an opposite direction to the “Y” direction). The plurality of battery cells 200 may be configured to extend such that the first direction (the “X” direction or an opposite direction to the “X” direction) becomes a lengthwise direction thereof. The first direction (the “X” direction or an opposite direction to the “X” direction) and the second direction (the “Y” direction or an opposite direction to the “Y” direction) may be perpendicular to each other.

A pair of end plates 300 may be provided. The pair of end plates 300 may be configured to be disposed on opposite sides of the plurality of battery cells 200 in the second direction (the “Y” direction or an opposite direction to the “Y” direction). The pair of end plates 300 may be configured to support the plurality of battery cells 200 that are disposed between the pair of end plates 300 while accommodating them.

The pair of end plates 300 may be configured to apply a surface-pressure to the plurality of battery cells 200 to prevent swelling of the plurality of battery cells 200.

The sensing assembly 400 may comprise a bus bar 410 that is configured to be electrically connected to each of the plurality of battery cells 200, and a bus bar frame 420 that is configured to support the bus bar 410.

A pair of sensing assemblies 400 may be provided and configured to be disposed on opposite sides of the plurality of battery cells 200 in the first direction (the “X” direction or an opposite direction to the “X” direction). The sensing assembly 400 may be disposed on opposite sides of the plurality of battery cells 200 in the first direction the “X” direction or an opposite direction to the “X”direction) and may cover an area between the pair of end plates 300.

The sensing assembly 400 may further comprise a sensing board (not illustrated) that is mounted on the bus bar frame 420.

The sensing cover 500 may be configured to cover an outer area of the sensing assembly 400. A pair of sensing covers 500 may be provided and configured to cover outer areas of each of the pair of sensing assemblies 400. The pair of sensing assemblies 400 and the plurality of battery cells 200 may be provided between the pair of sensing covers 500.

The sensing cover 500 may be configured to be fixed to the pair of end plates 300. Accordingly, the pair of sensing covers 500 and the pair of end plates 300 may be configured to accommodate the plurality of battery cells 200 in the interiors thereof.

The cover member 600 may be configured to cover one surface of at least one of the plurality of battery cells 200, which faces one side (the “Z” direction) in the third direction. A plurality of cover members 600 may be provided to each of at least one battery cell 200. Here, the third direction (the “Z” direction or an opposite direction to the “Z” direction) may be a direction that is perpendicular to both the first direction (the “X” direction or an opposite direction to the “X” direction) and the second direction (the “Y” direction or an opposite direction to the “Y” direction).

The cover member 600 may be configured to cover one surface of the battery cell 200 when the battery cell 200 is operated normally, so that foreign substances may be prevented from being introduced into the battery cell 200, and may be formed such that a space between the cover member 600 and the battery cell 200 may be expandable by a specific pressure when a fire occurs in the battery cell 200.

The cover member 600 may be formed of a flame-retardant material with an improved fire resistance or a heat-insulating material with an improved thermal insulation, rather than a plastic material. With this structure, the cover member 600 may be configured to not be melted even when a fire occurs in the battery cell 200.

The cover member 600 may be configured to extend such that the first direction (the “X” direction or an opposite direction to the “X” direction) becomes a lengthwise direction thereof so that spaces between the battery cells 200 and the cover member 600 communicate with each other with respect to the first direction (the “X” direction or an opposite direction to the “X” direction).

That is, the cover member 600, according to an exemplary embodiment of the present disclosure, is a configuration for covering at least one battery cell 200, respectively, and may be a configuration for expanding the space between any one cover members 600 that covers the battery cell 200, in which a fire has occurred, among the plurality of cover members 600, and the battery cell 200.

Accordingly, the cover member 600 may be formed such that a plurality of spaces, which are partitioned along the second direction (the “Y” direction or an opposite direction to the “Y” direction), among spaces between the cover member 600 and the battery cells 200, may be expandable by a specific pressure, respectively.

Meanwhile, the battery module 100 may comprise one or more cooling plates 210 and surface-pressure members 220 that are disposed between the plurality of battery cells 200.

As an example, the cooling plates 210 and the surface-pressure members 220 may be disposed between the plurality of battery cells 200, and the cooling plates 210 and the surface-pressure members 220 may be alternately arranged along the second direction (the “Y” direction or an opposite direction to the “Y”direction).

The cooling plate 210 may be a configuration for absorbing heat from the battery cells 200 to prevent the temperature of the battery cells 200 from rising. The surface-pressure member 220 may be a configuration for applying a surface pressure to the battery cells 200 that do not directly contact the end plate 300.

The surface-pressure member 220 may be configured to protrude closer to the pack cover 10 than to the battery cells 200. That is, the surface-pressure member 220 may have a greater height to one side (the “Z”direction) in the third direction than the battery cells 200.

The cover member 600 may be configured to be fixed by the end plate 300 or the surface-pressure member 220. That is, a pair of cover members 600, among the plurality of cover members 600, may be configured to be disposed between the end plate 300 and the surface-pressure member 220, may contact the end plate 300 and the surface-pressure member 220, and the remaining cover members 600, among the plurality of cover members 600, may be disposed between a pair of adjacent surface-pressure members 220 and may be fixed by the pair of surface-pressure members 220.

More specifically, the cover member 600 may comprise a support area 610, a folding area 620, and an expansion area 630. The support areas 610 may be portions of the cover member 600, which are parallel to each other, and may be areas that are supported by the end plates 300 or the surface-pressure members 220. The folding areas 620 may be area that are connected to the pair of support areas 610, respectively, and may be formed to be folded. The expansion area 630 may be an area that is disposed between the pair of folding areas 620 and may be connected to the pair of folding areas 620.

As illustrated in FIG. 4, when the battery cell 200 is operated normally, the folding area 620 of the cover member 600 may be fixed, and the expansion area 630 of the cover member 600 may cover one surface of at least one battery cell 200.

However, as illustrated in FIG. 5, when a fire occurs in the battery cell 200, the folding area 620 of the cover member 600 that covers one surface of the battery cell 200, in which the fire has occurred, may be configured to be unfolded due to pressure. Accordingly, a space between the cover member 600 and the battery cell 200 may be expanded.

Because the cover member 600 may extend parallel to the lengthwise direction of the battery cells 200, a fluid or foreign substances, such as flames, which are generated from the battery cell 200, in which a fire has occurred, may flow through a space between the cover member 600 and the battery cells 200 in the first direction (the “X” direction or an opposite direction to the “X”direction) and may be discharged to the outside of the battery module 100.

Furthermore, although not illustrated, a venting device (not shown) that is formed to be broken when a pressure may be applied, to communicate an interior and an exterior of the battery pack may be provided on a side of the battery module 100 in a first direction (the “X” direction or an opposite direction to the “X”direction).

With this structure, even when a fire occurs in the interior the battery module 100, a fluid or foreign substance, such as flames, from the battery cell 200, in which the fire has occurred, may be prevented from being introduced into adjacent other battery cells 200, so that a thermal runaway in in the interior of the battery module 100 may be prevented.

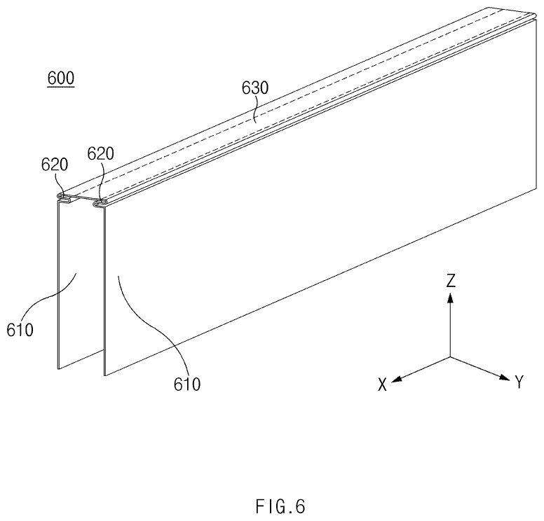

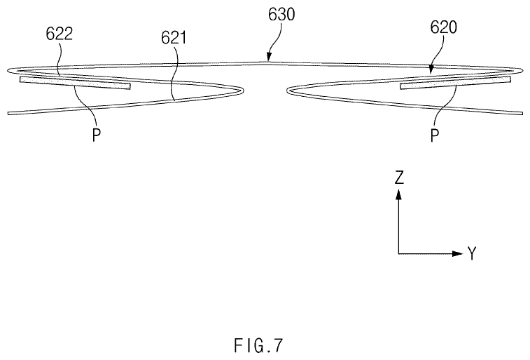

FIG. 6 illustrates a perspective view of a cover member, according to an exemplary embodiment of the present disclosure. FIG. 7 illustrates a schematic view of a folding area, according to an exemplary embodiment of the present disclosure.

Referring to FIGS. 6 and 7, it may be identified that a cover member 600 that covers at least one battery cell 200 (see FIG. 3) is illustrated.

As described above, the cover member 600 may comprise a pair of support areas 610 that may be configured to extend parallel to each other to contact the end plates 300 or the surface-pressure members 220, folding areas 620 that are connected to the pair of support areas 610, respectively, and formed to be folded, and an expansion area 630 that connects the pair of folding areas 620.

The folding area 620 may comprise a first folding area 621 and a second folding area 622. The first folding area 621 may comprise a portion that is connected to the support area 610, and the second folding area 622 may comprise a portion that is connected to the first folding area 621 and is fixed to the first folding area 621 on one side (the “Z” direction) in the third direction. The first folding area 621 and the second folding area 622 may be configured to cover an overlapping area.

According to an exemplary embodiment of the present disclosure, facing surfaces of the first folding area 621 and the second folding area 622 may be bonded to each other by an adhesive “P”.

The first folding area 621 and the second folding area 622, which are bonded to each other by an adhesive “P”, may be configured to be temporarily fixed in position with respect to each other, so that the position of the expansion area 630 may be fixed such that the expansion area 630 covers one surface of the battery cell 200.

However, when a pressure of a specific level or more is applied from the battery cell 200, the first and second folding areas 621 and 622 bonded to each other by the adhesive “P” may be configured to be separated from each other and be formed in a straight line.

Accordingly, a space between the expansion area 630 and the battery cell 200 may be configured to be expanded. However, the fixed structure of the first folding area 621 and the second folding area 622 is not limited thereto, and it is sufficient as long as the first folding area 621 and the second folding area 622 are separated from each other by the pressure of the specific level or more.

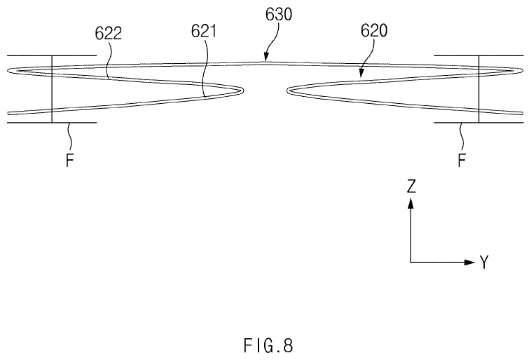

FIG. 8 illustrates a schematic view of a folding area, according to an exemplary embodiment of the present disclosure.

Referring to FIG. 8, the battery module 100 may further comprise a fixing member “F” that is configured to fix the first folding area 621 and the second folding area 622 together. Here, the description of the structure of the first folding area 621, the second folding area 622, and the expansion area 630 will be used for a description of FIG. 7.

As an example, the fixing member “F” may comprise a member having an “I” shape. The fixing member “F” may be configured to pass through the first folding area 621 and the second folding area 622 together and may be configured to fix portions of the first and second folding areas 621 and 622 and the expansion area 630 together.

The first folding area 621 and the second folding area 622, which are bonded to each other by the fixing member “F”, may be configured to be temporarily fixed in position with respect to each other, so that the position of the expansion area 630 may be fixed such that the expansion area 630 covers one surface of the battery cell 200.

However, when a pressure of a specific level or more is applied from the battery cell 200, the first and second folding areas 621 and 622 bonded to each other by the fixing member “F” may be configured to be separated from each other and be formed in a straight line. Accordingly, the spaces between the expansion area 630 and the battery cells 200 may be expanded.

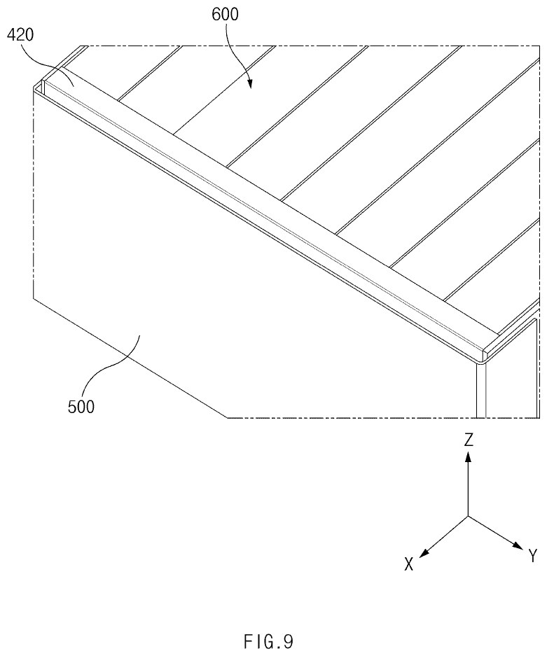

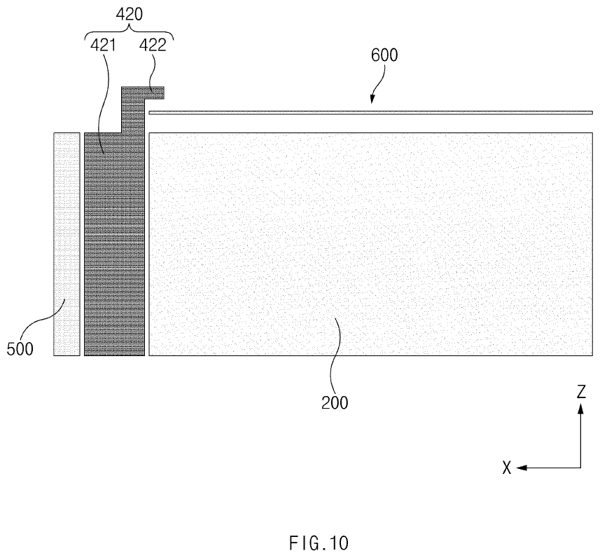

FIG. 9 illustrates an enlarged perspective view of a sensing cover, a bus bar frame, and a cover member, according to an exemplary embodiment of the present disclosure. FIG. 10 illustrates a longitudinal cross-sectional view of a sensing cover, a bus bar frame, a cover member, and a battery cell, according to an exemplary embodiment of the present disclosure.

Referring to FIGS. 9 and 10, the cover member 600 may need to be fixed in position when the battery cell 200 is operated normally, according to an exemplary embodiment of the present disclosure. In particular, opposite side areas of each of the plurality of cover members 600 in the first direction (the “X” direction or an opposite direction to the “X” direction) may need to be supported.

To this end, the cover member 600 may be covered by the bus bar frame 420 or the sensing cover 500. As an example, the bus bar frame 420 may be configured to protrude more than the sensing cover 500 and may be configured to extend to cover a portion of the cover member 600.

That is, the bus bar frame 420 may comprise a frame body area 421 that is covered by the sensing cover 500 and a frame protrusion area 422 that protrudes from the frame body area 421 and extends further toward the cover member 600. Although it is illustrated in the drawing that the frame protrusion area 422 is spaced apart from the cover member 600, the present disclosure is not limited thereto, and the frame protrusion area 422 and the cover member 600 may contact each other.

The frame body area 421 may comprise a portion of the bus bar frame 420, which is disposed between the sensing cover 500 and the battery cell 200, and the frame protrusion area 422 may comprise a portion that protrudes from the frame body area 421 to one side (the “Z” direction) in the third direction and covers a portion of the cover member 600.

With this structure, because each of the plurality of cover members 600 is supported by the frame protrusion area 422 of each of the pair of bus bar frames 420, the cover member 600 may be configured to be fixed in position without being expanded when a pressure in a space between the cover member 600 and the battery cell 200 is a specific pressure or less. Accordingly, the cover member 600 may be configured to cover one surface of the battery cell 200, so that fluid or foreign substances, such as flames, may be prevented from being introduced into the battery cell 200, in which a fire has not occurred.

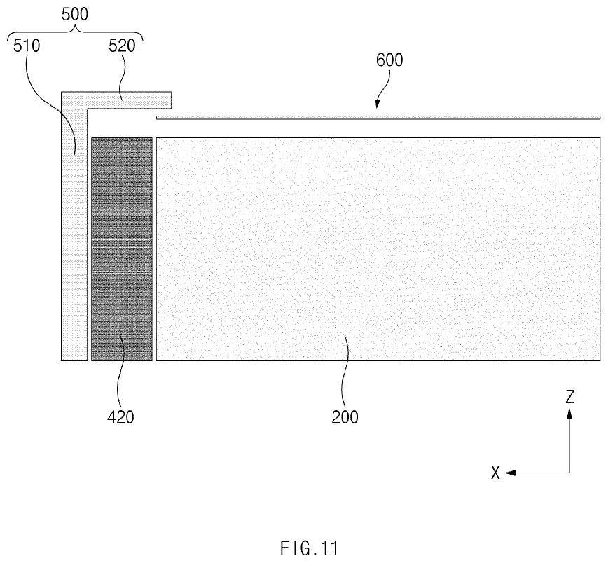

FIG. 11 illustrates a longitudinal cross-sectional view of a sensing cover, a bus bar frame, a cover member, and a battery cell, according to an exemplary embodiment of the present disclosure.

Referring to FIG. 11, unlike in FIG. 10, the sensing cover 500 may be configured to protrude more than the bus bar frame 420 and may be configured to extend to cover a portion of the cover member 600.

That is, the sensing cover 500 may comprise a cover body area 510 that is configured to cover one surface of the bus bar frame 420 and a cover protrusion area 520 that is configured to protrude from the cover body area 510 to cover the cover member 600. Although it is illustrated in the drawing that the cover protrusion area 520 is spaced apart from the cover member 600, the present disclosure is not limited thereto, and the cover protrusion area 520 and the cover member 600 may contact each other.

The cover body area 510 may comprise a portion of the sensing cover 500, which covers the sensing assembly 400 (see FIG. 2), and the cover protrusion area 520 may comprise a portion that protrudes from the cover body area 510 to one side (the “Z” direction) in the third direction to cover a portion of the cover member 600.

With this structure, because each of the plurality of cover members 600 is supported by the cover protrusion area 520 of each of the pair of sensing covers 500, the cover member 600 may be configured to be fixed in position without being expanded when a pressure in a space between the cover member 600 and the battery cell 200 is a specific pressure or less. Accordingly, the cover member 600 may be configured to cover one surface of the battery cell 200, so that fluid or foreign substances, such as flames, may be prevented from being introduced into the battery cell 200.

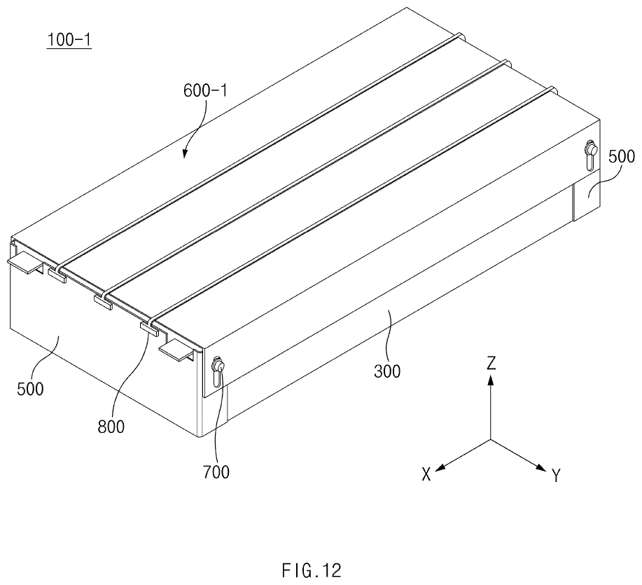

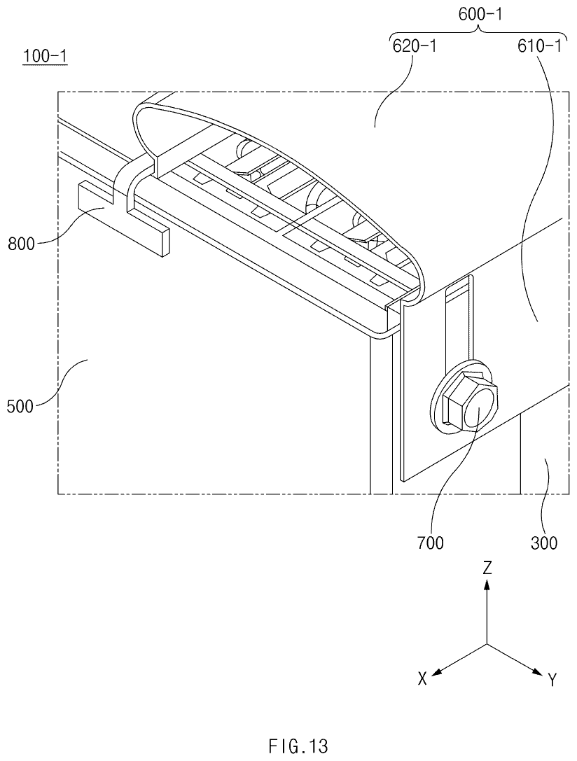

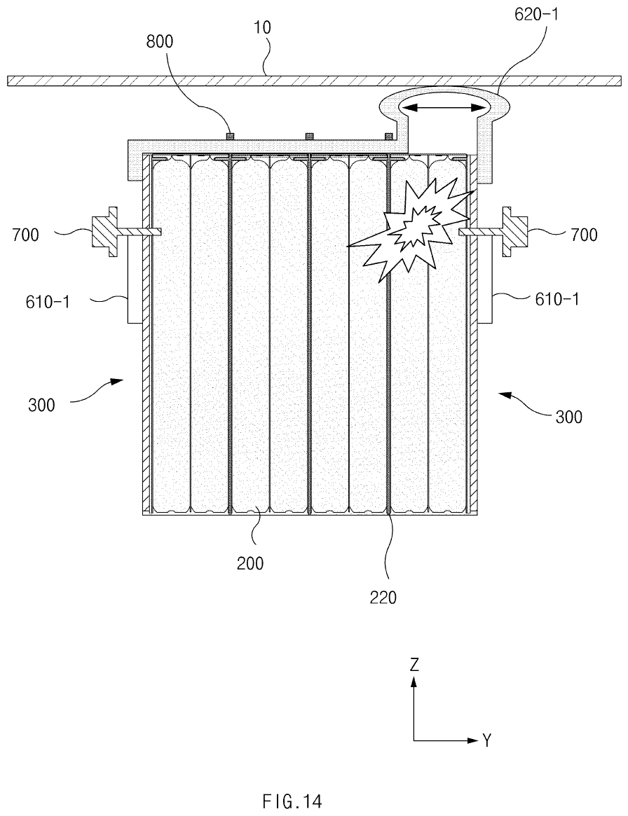

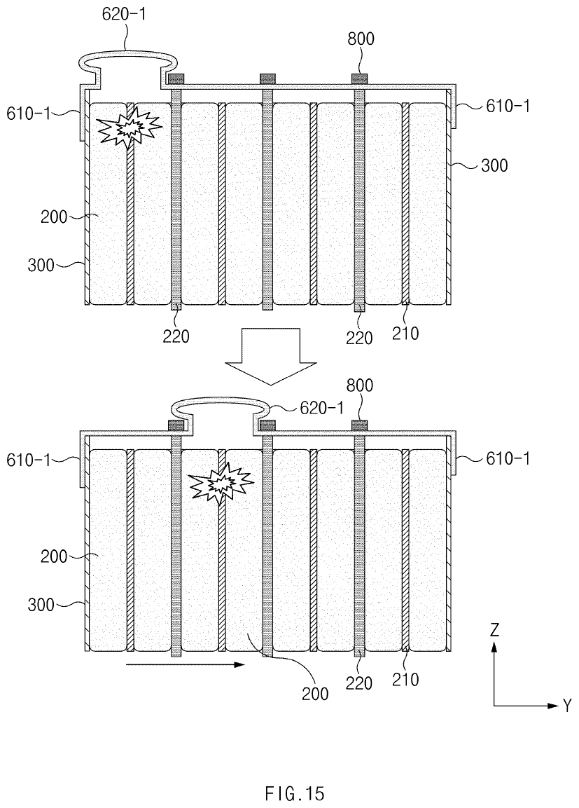

FIG. 12 illustrates a perspective view of a battery module, according to an exemplary embodiment of the present disclosure. FIG. 13 illustrates an enlarged perspective view of a battery module, according to an exemplary embodiment of the present disclosure. FIG. 14 illustrates a transverse cross-sectional view of a battery module, according to an exemplary embodiment of the present disclosure. FIG. 15 illustrates a transverse cross-sectional view of a battery module illustrating a state, in which a space provided between a battery cell and a cover member is expanded due to a thermal transfer, according to an exemplary embodiment of the present disclosure.

Referring to FIGS. 12 to 15, unlike the structure, in which a plurality of cover members 600 are provided to cover at least one battery cell 200, respectively, according to the above-described embodiment of the present disclosure, a cover member 600-1 according to another embodiment of the present disclosure may comprise a single configuration and may comprise a structure that is partitioned by a cover fixing member 800.

The cover member 600-1 may be formed of a flame-retardant material with an improved fire resistance or a heat-insulating material with an improved thermal insulation, rather than a plastic material. With this structure, the cover member 600 may be configured to not be melted even when a fire occurs in the battery cell 200.

The cover member 600-1 may be configured to extend such that the first direction (the “X” direction or an opposite direction to the “X” direction) becomes a lengthwise direction thereof so that spaces between the battery cells 200 and the cover member 600-1 communicate with each other with respect to the first direction (the “X” direction or an opposite direction to the “X”direction).

The battery module 100-1 may comprise the cover member 600-1 that is fixed by the end plate 300 or the surface-pressure member 220, covers surfaces of the plurality of battery cells 200, and is formed such that a plurality of spaces partitioned by the cover fixing member 800 in the second direction (the “Y” direction or an opposite direction to the “Y” direction), among the spaces between the cover member 600-1 and the battery cells 200, may be expanded by a specific pressure.

The cover member 600-1 may be formed of a flexible material. The cover member 600-1 may be configured to be fixed to the pair of end plates 300 that are disposed on opposite sides of the plurality of battery cells 200 in the second direction (the “Y” direction or an opposite direction to the “Y”direction), respectively.

Furthermore, the cover member 600-1 may be configured to be fixed by each of the plurality of surface-pressure members 220 to be partitioned in the second direction (the “Y” direction or an opposite direction to the “Y”direction).

In other words, the cover member 600-1 may comprise a pair of end fixing areas 610-1 that are fixed to the pair of end plates 300, respectively, and a cover area 620-1 that connects the pair of end fixing areas 610-1 and contacts the surface-pressure member 220.

The battery module 100-1 may comprise an end fixing member 700 that is configured to allow the end fixing area 610-1 to pass through the end plate 300 to fix the end fixing area 610-1 to the end plate 300, and a cover fixing member 800 that is configured to allow the cover area 620-1 to pass to bring a portion of the cover area 620-1 into contact with the surface-pressure member 220.

The end fixing member 700 may be formed in the shape of a bolt, according to an exemplary embodiment.

The cover fixing member 800 may be configured to extend such that a direction that is parallel to the lengthwise direction of the battery cells 200 becomes a lengthwise direction thereof, and opposite ends of the cover fixing member 800 may be supported by the sensing cover 500. A plurality of cover fixing members 800 may be provided to be spaced apart from each other along a direction, in which the battery cells 200 are arranged, and the plurality of cover fixing members 800 may be configured to bring portions of the cover areas 620-1 into contact with the surface-pressure members 220, respectively.

With the above-described structure, the elastic cover member 600-1 may be configured to be fixed in opposite end areas by the end fixing members 700, and may be configured to cover one surface of at least one battery cell 200 at each section partitioned by the plurality of cover fixing members 800.

As illustrated in FIGS. 13 and 14, when a fire occurs in at least one battery cell 200 of the battery module 100-1, a space between the cover area 620-1 that faces the battery cell 200 in which the fire has occurred, and the battery cell 200 may be expanded, so that a thermal runaway may be prevented from occurring in adjacent other battery cells 200.

Accordingly, a fluid or foreign substances, such as flames, from the battery cell 200, in which the fire has occurred, may flow through a space between the cover area 620-1 and the battery cell 200 in the first direction (the “X” direction or an opposite direction to the “X” direction), and may be discharged to the outside of the battery module 100-1.

Meanwhile, as illustrated in FIG. 15, even when a fire occurs in another battery cell 200 due to a heat transfer from the battery cell 200 that is adjacent to the battery cell 200, in which the fire has occurred, only the cover area 620-1 that covers one surface of the battery cell 200, to which the heat is transferred, may be deformed, and a fluid or foreign substances, such as flames, which are generated from the battery cell 200, to which the heat is transferred, may be prevented from being introduced into yet another battery cell 200. Accordingly, the safety of the battery module 100-1, according to an exemplary embodiment of the present disclosure, may also be improved.

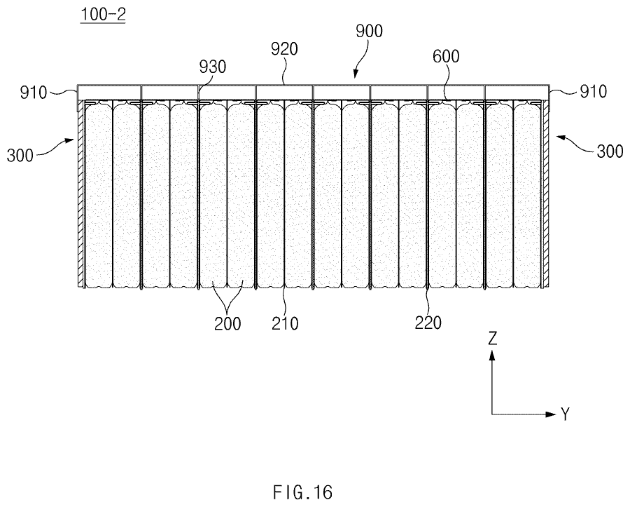

FIG. 16 illustrates a transverse cross-sectional view of a battery module, according to an exemplary embodiment of the present disclosure.

Referring to FIG. 16, a battery module 100-2, according to an exemplary embodiment of the present disclosure, may be an embodiment that further comprises a cover frame 900 in addition to the structure of the battery modules 100 and 100-1 described above.

The cover frame 900 may be configured to be fixed to the end plate 300 or the surface-pressure member 220, and may be configured to cover a surface that faces an outer side of the cover member 600. The cover frame 900 may be disposed on one side (the “Z” direction) in the third direction with respect to the cover member 600.

The cover frame 900 may be configured to be coupled to each of the pair of end plates 300 and be fixed in position. The cover frame 900 may be configured to extend such that a direction that is parallel to the lengthwise direction of the battery cell 200 becomes the lengthwise direction thereof.

The cover frame 900 may comprise a pair of plate coupling areas 910 that are coupled to the pair of end plates 300, respectively, a frame cover area 920 that connects the pair of plate coupling areas 910 and covers one surface of the cover member 600, and a plurality of partition areas 930 that protrude from the frame cover area 920 toward the surface-pressure member 220.

When the cover frame 900 is applied to the battery module 100, as illustrated in FIG. 16, the cover member 600 may be provided between a pair of adjacent partition areas 930. The cover frame 900 may also be formed of a flame-retardant or heat-insulating material.

With this structure, when a fire occurs in the battery cell 200, the folding of the cover member 600 that covers the battery cell 200, in which the fire has occurred, may be released, so that a space between the cover member 600 and the battery cell 200 may be expanded, and even when the cover member 600 is damaged, a fluid or foreign substances, such as flames, may be prevented from being exposed to an adjacent cover member 600 or an adjacent battery cell 200.

Furthermore, when the cover frame 900 is applied to the battery module 100-1, a portion of the cover area 620-1, which is supported by a pair of adjacent cover fixing members 800 (see FIG. 12), may be provided between a pair of adjacent partition areas 930.

With this structure, when a fire occurs in the battery cell 200, the cover area 620-1 that covers the battery cell 200, in which the fire has occurred may be stretched or contracted, so that a space between the cover area 620-1 and the battery cell 200 may be expanded, and even when the cover area 620-1 is damaged, a fluid or foreign substances, such as flames, may be prevented from being exposed to another adjacent cover area 620-1 or an adjacent battery cell 200.

Accordingly, the battery module 100-2 may be configured to more effectively prevent a thermal runaway due to the cover frame 900 of the present disclosure, and the safety of the battery module 100-2 may be improved.

According to the present technology, when a fire occurs in a battery cell, the spaces between the battery cells and the cover member may be allowed to be expanded while the cover member covers one surface of the battery cell, so that a fluid or foreign substances, such as flames, caused by the fire may be discharged to the outside of the battery module through the lengthwise direction of the battery cell without being introduced into adjacent battery cells, whereby a thermal runaway of the battery module may be prevented.

Furthermore, according to the present technology, because the cover member may be partitioned along at least one battery cell, fluid or foreign substances, such as flames, caused the battery cell, in which a fire has occurred, may be prevented from being introduced into other battery cells, so that a thermal runaway of the battery module may be prevented.

Furthermore, according to the present technology, because the busbar frame or the sensing cover supports a portion of the cover member, the cover member may cover one surface of the battery cell, so that foreign substances may be prevented from being introduced into the battery cell.

In addition, according to the present technology, because the cover frame may cover the cover member, even when the spaces between the cover member and the battery cells are expanded, fluid or foreign substances, such as flames, caused by a fire may be effectively prevented from being introduced into other adjacent battery cells.

Besides, a variety of effects directly or indirectly understood through the present disclosure may be provided.

The above description is merely an example of the technical idea of the present disclosure, and various modifications and variations may be made by one skilled in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

What is claimed is:

1. A battery module comprising:
a plurality of battery cells,
wherein a plurality of spaces are partitioned between the plurality of battery cells;
an end plate configured to support the plurality of battery cells;
a surface-pressure member disposed between the plurality of battery cells; and
a cover member configured to cover a surface of at least one battery cell, of the plurality of battery cells,
wherein each of the plurality of spaces partitioned is configured to be expandable by pressure.

2. The battery module of claim 1, wherein the cover member comprises:
a support area supported by the end plate or the surface-pressure member; and
a folding area connected to the surface area and configured to be folded.

3. The battery module of claim 2, wherein the folding area comprises:
a first folding area; and
a second folding area:
connected to the first folding area; and
fixed to the first folding area on a side of the first folding area.

4. The battery module of claim 3, wherein:
the first folding area and the second folding area comprise facing surfaces, and
the facing surfaces of the first folding area and the second folding area are bonded to each other.

5. The battery module of claim 3, further comprising a fixing member configured to fix the first folding area and the second folding area.

6. The battery module of claim 1, further comprising:
a sensing assembly comprising:
a busbar electrically connected to the plurality of battery cells; and
a busbar frame configured to support the busbar; and
a sensing cover configured to cover the sensing assembly,
wherein the busbar frame or the sensing cover are configured to cover the cover member.

7. The battery module of claim 6, wherein the busbar frame comprises:
a frame body area covered by the sensing cover; and
a frame protrusion area configured to protrude from the frame body area to cover a portion of the cover member.

8. The battery module of claim 6, wherein the sensing cover comprises:
a cover body area configured to cover a surface of the busbar frame; and
a cover protrusion area configured to protrude from the cover body area to cover the cover member.

9. The battery module of claim 1, wherein the cover member comprises a flexible material.

10. The battery module of claim 1, further comprising a pair of end plates disposed on opposite sides of the plurality of battery cells,
wherein the cover member comprises:
a pair of end fixing areas fixed to the pair of end plates, respectively; and
a cover area configured to:
connect the pair of end fixing areas; and
contact the surface-pressure member.

11. The battery module of claim 10, further comprising:
an end fixing member configured to enable the end fixing area and the end plates to pass therethrough to fix the end fixing area; and
a cover fixing member configured to bring a portion of the cover area into contact with the surface-pressure member.

12. The battery module of claim 1, wherein:
the plurality of battery cells are arranged in a direction, and
the cover member is configured to extend such that a direction crossing the direction in which the plurality of battery cells are arranged becomes a lengthwise of the cover member so that the plurality of spaces communicate with each other with respect to a direction crossing the one direction.

13. The battery module of claim 1, further comprising a cover frame fixed to the end plate or the surface-pressure member, and covering the cover member.

14. The battery module of claim 13, further comprising a pair of end plates disposed on opposite sides of the plurality of battery cells,
wherein the cover frame comprises:
a pair of plate coupling areas coupled to the pair of end plates, respectively;
a frame cover area configured to:
cover the cover member; and
connect the pair of plate coupling areas; and
a partition area configured to protrude from the frame cover area toward the surface-pressure member.

15. The battery module of claim 1, wherein the cover member comprises a flame-retardant material or a heat-insulating material.

16. A battery module comprising:
an end plate configured to support a plurality of battery cells;
a surface-pressure member disposed between the plurality of battery cells; and
a cover member configured to cover a surface of at least one battery cell, of the plurality of battery cells.

17. The battery module of claim 16, wherein the cover member comprises:
a support area supported by the end plate or the surface-pressure member; and
a folding area connected to the surface area and configured to be folded.

18. The battery module of claim 17, wherein the folding area comprises:
a first folding area; and
a second folding area:
connected to the first folding area; and
fixed to the first folding area on a side of the first folding area.

19. The battery module of claim 18, wherein:
the first folding area and the second folding area comprise facing surfaces, and
the facing surfaces of the first folding area and the second folding area are bonded to each other.

20. The battery module of claim 18, further comprising a fixing member configured to fix the first folding area and the second folding area.
